(19) United States
(12) Patent Application Publication
(10) Pub. No.: US 2008/0304568 A1
(43) Pub. Date: Dec. 11, 2008

(54) METHOD FOR MOTION-COMPENSATED FRAME RATE UP-CONVERSION

(75) Inventor: Fang Chen Chang, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/761,015

(22) Filed: Jun. 11, 2007

(51) Int. Cl. H04B 1/66

(52) U.S. Cl. 375/240.16

(57) ABSTRACT

The method for motion-compensated frame rate up-conversion includes the step of detecting a film-mode video signal comprising a sequence of 3-2 pull-down frames, and extracting a sequence of feature frames from the sequence of 3-2 pull-down frames. In addition, a motion vector for each pair of the sequence of feature frames is calculated. Also, a plurality of intermediate frames between each pair of the sequence of feature frames is interpolated based on the corresponding motion vector.

### BACKGROUND OF THE INVENTION

1. Field of the Invention

The present invention relates to a signal processing of motion-compensated frame rate up-conversion, and more particularly, to an improved signal-processing method for displaying film-originated video signals without motion discontinuities.

2. Description of the Related Art

To convert motion-picture-film-source television signals for display on computer-type monitors and television sets having increased frame rate displays, particularly frame rates of 72 Hz, 96 Hz and 120 Hz, a deinterlacing technique is usually implemented to progressively scan the display. A popular method to deinterlace an interlaced NTSC television signal having 24 frames per second is to merge opposite polarity pairs of interlaced parts coming from the same film source. Each merged pair is repeated at least twice to form a 3-2 pull-down pattern. Thus, the deinterlaced signals have the same frame rate as the original interlaced display signals. Sometimes the deinterlaced 60 Hz progressive scan signals are doubled to 120 Hz frame rate. As a result, a 6-4 pattern is formed. However, a motion discontinuity could be visible in the 6-4 pattern.

### SUMMARY OF THE INVENTION

The method for motion-compensated frame rate up-conversion in accordance with an embodiment of the present invention comprises the following steps: detecting a film-mode video signal composing a sequence of 3-2 pull-down frames, extracting a sequence of feature frames from the sequence of 3-2 pull-down frames, calculating a motion vector for each pair of the sequence of feature frames, and interpolating a plurality of intermediate frames between each pair of the sequence of feature frames based on the corresponding motion vector.

The method for motion-compensated frame rate up-conversion for a film-oriented video signal in accordance with another embodiment of the present invention comprises the following steps: detecting the film-oriented video signal having a 3-2 pull-down pattern, doubling a frame rate of the film-oriented video signal maintaining the 3-2 pull-down pattern into a 6-4 pattern, wherein the film-oriented video signal comprises a plurality of 6-sequences and 4-sequences arranged alternately, and replacing four consecutive frames covering each boundary of the 6-sequences and the 4-sequences of the film-oriented video signal with four compensated frames to form a compensated video signal.

### BRIEF DESCRIPTION OF THE DRAWINGS

The invention will be described in accordance with the appended drawings in which:

FIGS. 1(a) to 1(c) depict the forming process for motion-compensated frame rate up-conversion in accordance with an embodiment of the present invention;

FIGS. 2(a) to 2(c) depict the detecting method for the film-oriented video signals having a 3-2 pull-down pattern in accordance with one embodiment of the present invention; and

FIGS. 3(a) and 3(b) show examples of detecting the film-oriented video signal having a 3-2 pull-down pattern.

### PREFERRED EMBODIMENT OF THE PRESENT INVENTION

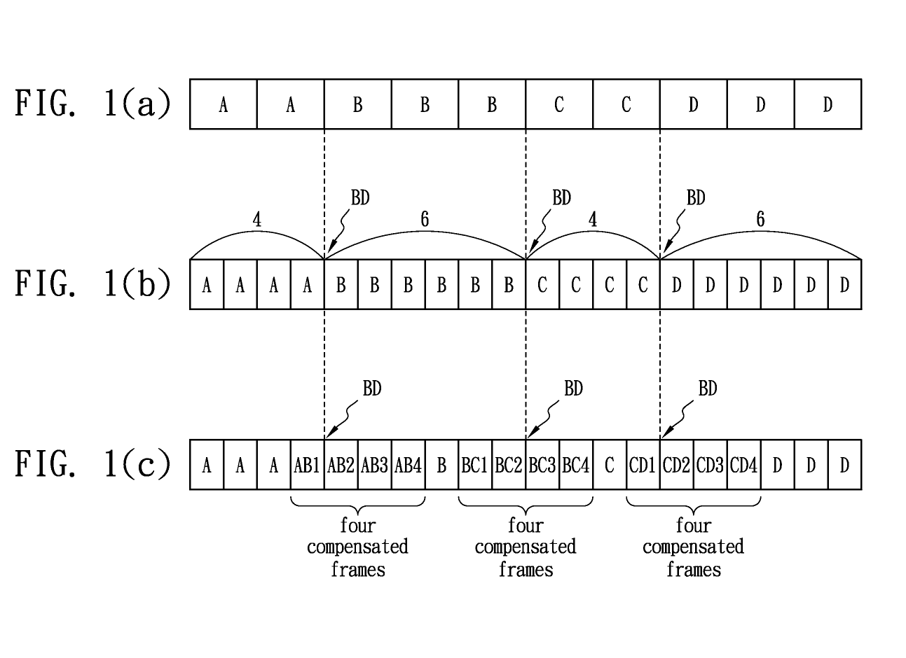

FIGS. 1(a) to 1(c) depict the forming process for motion-compensated frame rate up-conversion in accordance with an embodiment of the present invention. FIGS. 1(a) and 1(b) show deinterlaced 60 Hz video with a 3-2 pull-down pattern and frame-doubled 120 Hz video with a 6-4 pull-down pattern, respectively. FIG. 1(c) shows the present pattern corresponding to the 3-2 and 6-4 pull-down patterns in FIGS. 1(a) and 1(b). In this embodiment, the present pattern is formed by calculating motion vectors based on the original 3-2 pull-down sequence and replacing one or two duplicate frames with motion-compensated frames, the number of which is four.

To form the present pattern in accordance with one embodiment of the present invention, a film-mode video signal comprising a sequence of 3-2 pull-down frames is detected and a sequence of feature frames from the sequence of 3-2 pull-down frames is extracted first. Thereafter, a motion vector for each pair of the sequence of feature frames is calculated, and a plurality of intermediate frames between each pair of the sequence of feature frames based on the corresponding motion vector is interpolated. The embodiment of the present invention performs a film-mode detection before the frame rate conversion, and performs actions of motion estimation and compensation to a film source to keep the motion trajectory images continuous. Another embodiment of the present invention forms the pattern by doubling a frame rate of the film-oriented video signal maintaining the 3-2 pull-down pattern into a 6-4 pattern, where the film-oriented video signal comprises a plurality of 6-sequences and 4-sequences arranged alternately. Thereafter, four consecutive frames covering each boundary of the 6-sequences and the 4-sequences of the film-oriented video signal are replaced with four compensated frames. The compensated video signal has an uncompensated frame in each of the 6-sequences and the 4-sequences except for the first sequence and the last sequence thereof.

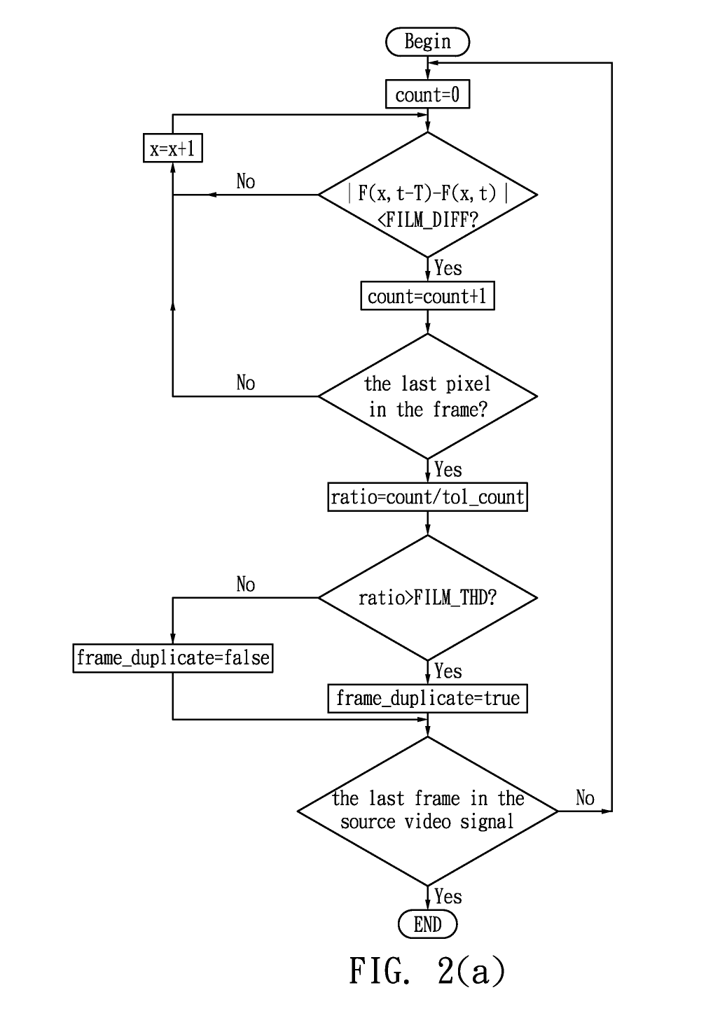

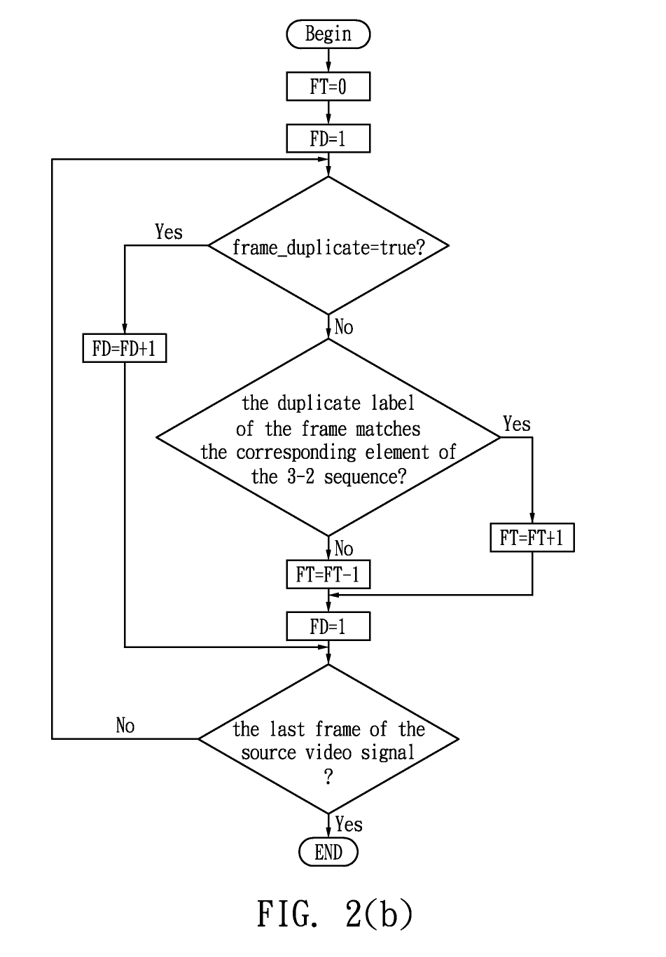

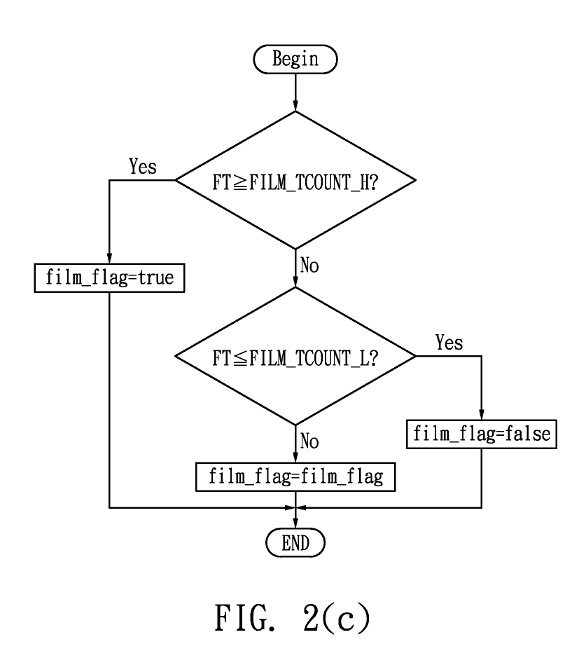

FIGS. 2(a) to 2(c) depict the detecting method for the film-oriented video signals having a 3-2 pull-down pattern in accordance with one embodiment of the present invention. The method is mainly made by receiving a source video signal comprising a plurality of frames, calculating a duplication label for each frame of the source video signal, and identifying the source video signal as the film-oriented video signal having a 3-2 sequence. The flow chart in FIG. 2(a) shows the method which determines whether the current frame is substantially the same as the previous one. First of all, each pixel of the current frame is compared with a corresponding pixel of the previous frame to adjust a count flag. The comparison could be done by the following equation.

if|F(x,t−T)−F(x,T)|<FILM_DIFF then (count++)

Where x represents the location of the pixel, T represents the frame interval, and the parameter FILM_DIFF represents an acceptable threshold value. An absolute value of the difference between the gray level values of each pixel of the current frame and the corresponding pixel of the previous frame is obtained. Also, the count flag increases by 1 if the absolute value is smaller than a first threshold FILM_DIFF. The following algorithm illustrates that if most pixels in these two frames are equal, then these two frames are regarded as duplicates.

ratio= count / tol_count;
if (ratio > FILM_THD) then frame_duplicate = true
else frame_duplicate = false

Where the parameter to1_count represents the total number of a frame, and FILM_THD represents an acceptable threshold value. First of all, whether or not the current frame and the previous frame are identified as two duplicate frames is in accordance with the ratio of the count flag to the total pixel number of the current frame. The duplication label in accordance with the ratio of the count flag is adjusted to the total pixel number of the current frame. The above steps are repeated for each frame of the source video signals.

The flow chart in FIG. 2(b) shows the method which calculates a duplication label for each frame of the source video signals. First of all, the duplication label with a corresponding element of the 3-2 sequence is compared in each frame from the first to the last in the source video signals. Thereafter, a tally flag is adjusted in accordance with the result of comparison. Next, the source video signals are identified as the film-oriented video signal having the 3-2 pull-down pattern in accordance with the tally flag.

if (frame_duplicate == true) then (film_dcount ++)
else
{
if (film_dcount == film_pattern (2 or 3)) then (film_tallycount ++)
else film_tallycount −−
film_dcount = 1 /reset film_dcount/
}

Where the parameter film_dcount represents the number of continuous duplicates, film_pattern (2 or 3) represents a fixed pattern, and film_tallycount represents the number of matching the patterns.

The flow chart in FIG. 2(c) shows the method which calculates a duplication label for each frame of the source video signals. First of all, the source video signal is considered to be the film-oriented video signal which has a 3-2 pull-down pattern with the tally flag being larger than or equal to a second threshold. The algorithm is shown as the following:

if (film_tallycount >= FILM_TCOUNT_H) then film_flag = true;
else if (film_tallycount <= FILM_TCOUNT_L) then film_flag =false
else film_flag = film_flag

Where the parameter FILM_TCOUNT_H represents a high-level threshold, and FILM_TCOUNT_L represents a low-level threshold.

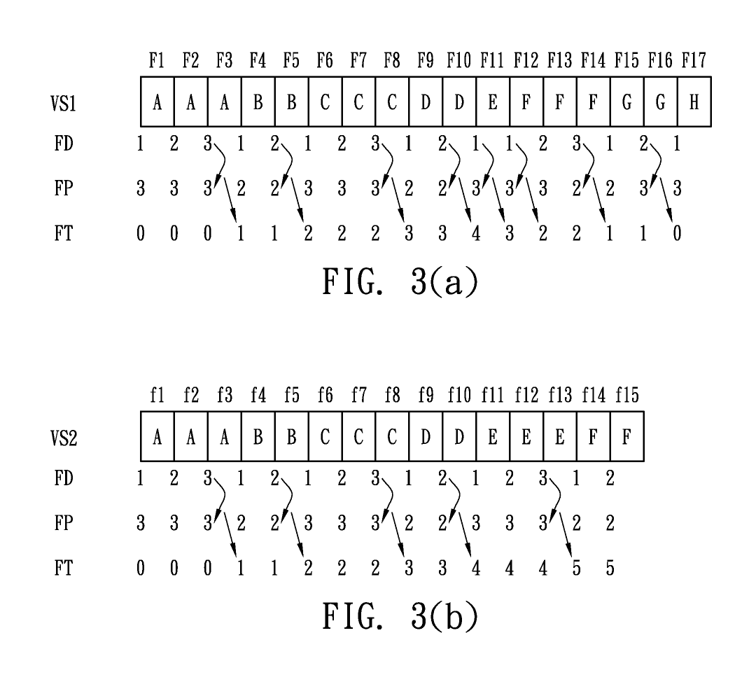

FIGS. 3(a) and 3(b) show examples of detecting the film-oriented video signal having a 3-2 pull-down pattern. Those examples are demonstrated based on the algorithms above and the flow charts of FIGS. 2(a) to 2(c), where FD is abbreviated from the parameter film_dcount, FP is abbreviated from the parameter film_pattern (2 or 3), and FT is abbreviated from the parameter film_tallycount. In FIG. 3(a), the frames from F1 to F10 satisfy the definition of 3-2 pull-down patterns, thus FT, which represents the number of 3-2 pull-down patterns, gradually increases up to 4. However, after frame F11, the 3-2 pull-down pattern no longer exists, thus FT gradually goes down to zero. In FIG. 3(b), the frames from f1 to f15 satisfy the definition of 3-2 pull-down pattern, thus FT gradually increases up to 5.

The above-described embodiments of the present invention are intended to be illustrative only. Numerous alternative embodiments may be devised by persons skilled in the art without departing from the scope of the following claims.

What is claimed is:

1. A method for motion-compensated frame rate up-conversion, comprising the steps of:
detecting a film-mode video signal composing a sequence of 3-2 pull-down frames;
extracting a sequence of feature frames from the sequence of 3-2 pull-down frames;
calculating a motion vector for each pair of the sequence of feature frames; and
interpolating a plurality of intermediate frames between each pair of the sequence of feature frames based on the calculated motion vector.

2. The method of motion-compensated frame rate up-conversion of claim 1, wherein the interpolating step comprises the step of replacing consecutive frames covering boundary of the 3-2 pull-down frames with the intermediate frames.

3. The method of motion-compensated frame rate up-conversion of claim 1, wherein the number of the intermediate frames is four.

4. A method of motion-compensated frame rate up-conversion, comprising the steps of:
detecting the film-oriented video signal having a 3-2 pull-down pattern;
doubling a frame rate of the film-oriented video signal transforming the 3-2 pull-down pattern into a 6-4 pattern, wherein the film-oriented video signal comprises a plurality of 6-sequences and 4-sequences arranged alternately; and
replacing four consecutive frames covering each boundary of the 6-sequences and the 4-sequences of the film-oriented video signal with four compensated frames to form a compensated video signal.

5. The method of motion-compensated frame rate up-conversion of claim 4, wherein the frame rate of the film-oriented video signal is 60 Hz.

6. The method of motion-compensated frame rate up-conversion of claim 4, wherein the frame rate of the doubled video signal is one of 72 Hz, 96 Hz and 120 Hz.

7. The method of motion-compensated frame rate up-conversion of claim 4, wherein the four compensated frames are interpolated in accordance with corresponding 6-sequences and 4-sequences.

8. The method of motion-compensated frame rate up-conversion of claim 4, wherein the compensated video signal has an uncompensated frame in each of the 6-sequences and the 4-sequences except for the first sequence thereof.

9. The method of motion-compensated frame rate up-conversion of claim 4, wherein the compensated video signal has an uncompensated frame in each of the 6-sequences and the 4-sequences except for the last sequence thereof.

10. The method of motion-compensated frame rate up-conversion of claim 4, wherein the detecting step is performed by comparing adjacent frames.

11. A method of motion-compensated frame rate up-conversion, comprising the steps of:
receiving a source video signal comprising a plurality of frames;
calculating a duplication label for each frame of the source video signal;
identifying the source video signal as the film-oriented video signal having a 3-2 sequence;
doubling a frame rate of the film-oriented video signal transforming the 3-2 pull-down pattern into a 6-4 pattern, wherein the film-oriented video signal comprises a plurality of 6-sequences and 4-sequences arranged alternately; and
replacing four consecutive frames covering each boundary of the 6-sequences and the 4-sequences of the film-oriented video signal with four compensated frames to form a compensated video signal.

12. The method of motion-compensated frame rate up-conversion of claim 11, wherein the step of calculating a duplication label for each frame of the source video signal comprises the steps of:
comparing each pixel of the current frame with a corresponding pixel of the previous frame to adjust a count flag;
identifying the current frame and the previous frame as two duplicate frames in accordance with the ratio of the count flag to the total pixel number of the current frame; and
adjusting the duplication label in accordance with the ratio of the count flag to the total pixel number of the current frame.

13. The method of motion-compensated frame rate up-conversion of claim 12, wherein the step of comparing each pixel of the current frame with a corresponding pixel of the previous frame to adjust a count flag comprises the steps of:
obtaining an absolute value of the difference between the gray level values of each pixel of the current frame and the corresponding pixel of the previous frame; and
increasing the count flag by 1 with the absolute value being smaller than a first threshold.

14. The method of motion-compensated frame rate up-conversion of claim 11, wherein the 3-2 sequence comprises a plurality of three sequences and two sequences arranged alternately.

15. The method of motion-compensated frame rate up-conversion of claim 11, wherein the step of identifying the source video signal as the film-oriented video signal having a 3-2 sequence comprises the steps of:
comparing the duplication label with a corresponding element of the 3-2 sequence in each frame from the first to the last in the source video signal;
adjusting a tally flag based on the comparison; and
identifying the source video signal as the film-oriented video signal having the 3-2 pull-down pattern in accordance with the tally flag.

16. The method of motion-compensated frame rate up-conversion of claim 11, wherein the source video signal is considered as the film-oriented video signal having the 3-2 pull-down pattern with the tally flag being larger than or equal to a second threshold.

17. The method of motion-compensated frame rate up-conversion of claim 11, wherein the source video signal is not considered as the film-oriented video signal having the 3-2 pull-down pattern with the tally flag being smaller than or equal to a third threshold.

18. The method of motion-compensated frame rate up-conversion of claim 11, wherein the frame rate of the film-oriented video signal is 60 Hz.

19. The method of motion-compensated frame rate up-conversion of claim 11, wherein the frame rate of the doubled video signal is one of 72 Hz, 96 Hz and 120 Hz.

20. The method of motion-compensated frame rate up-conversion of claim 11, wherein the compensated video signal has an uncompensated frame in each of the 6-sequences and the 4-sequences except for the first sequence and the last sequence thereof.
